(19) United States
(12) Patent Application Publication
(10) Pub. No.: US 2026/0039658 A1
(43) Pub. Date: Feb. 5, 2026

(54) ENDPOINT CLIENT APPLICATION AUTHENTICATION AND ACCESS CONTROL ON ZERO-TRUST NETWORKS

(71) Applicant: Fortinet, Inc., Sunnyvale, CA (US)

(72) Inventor: Reinhold Daniel Balogh, Bulach (CH)

(73) Assignee: Fortinet, Inc., Sunnyvale, CA (US)

(21) Appl. No.: 18/789,875

(22) Filed: Jul. 31, 2024

(51) Int. Cl. H04L 9/40

(52) U.S. Cl. CPC H04L 63/0876; H04L 63/102; H04L 63/20

(57) ABSTRACT

Approaches to endpoint client application authentication and access control in Zero-Trust Network Access (ZTNA) environments are described. A request for an application to access a remote secure resource via a network connection is processed. The request comprises at least an application identifier assigned by a security device. A secure network connection is opened to allow the application to access the remote secure resource. A verification of establishment of the network connection is received to allow access to the remote secure resource. Application data is transmitted over the network connection to access the remote secure resource. The presented approaches have a benefit that the ZTNA gateways gain full visibility about which application accesses the remote resource based on the client-app-ID. The ZTNA gateway can enforce access control rules based on the app-IDs of the network connection headers.

### BACKGROUND

Zero-trust network access (ZTNA) solutions help address current challenges with location-independent, secure application access. ZTNA solutions apply zero-trust principles, such as least privilege and strong authentication, when allowing application access. However, least privilege is usually only evaluated and implemented for users, devices, and destination application servers (backends). This provides an incomplete solution.

### TERMS AND DEFINITIONS

Brief definitions of terms used throughout this application are given below.

The term “client” generally refers to an application, program, process, or device in a client/server relationship that requests information or services from another program, process, or device (a server) on a network. Importantly, “client” and “server” are relative since an application may be a client to one application but a server to another. The term “client” also encompasses software that makes the connection between a requesting application, program, process, or device to a server possible, such as a file transfer protocol (FTP) client.

The phrase “endpoint protection platform” generally refers to cybersecurity monitoring and/or protection functionality performed on behalf of an endpoint (or client) device. In one embodiment, the endpoint protection platform can be deployed in the cloud or on-premises and supports multi-tenancy. The endpoint protection platform may include a kernel-level Next Generation AntiVirus (NGAV) engine with machine learning features that prevent infection from known and unknown threats and leverage code-tracing technology to detect advanced threats such as in-memory malware. The endpoint protection platform may provide monitoring and/or protection functionality on behalf of the endpoint device via an agent, which may be referred to herein as an “endpoint security agent” deployed on the endpoint device. Non-limiting examples of an endpoint protection platform include the FORTIEDR Software as a Service (SaaS) platform and the FORTICLIENT integrated endpoint protection platform available from Fortinet, Inc. of Sunnyvale, CA. In some examples, the endpoint protection platform is a participant in a cybersecurity mesh architecture (CSMA) in which various cybersecurity products/solutions/tools of a given cybersecurity or networking security vendor or across a group of participating vendors achieve a more integrated security policy by facilitating interoperability and communication among the various cybersecurity products/solutions/tools (e.g., network security appliances, a secure access service edge (SASE) platform, etc.).

The phrase “endpoint security agent” generally refers to endpoint software that runs on an endpoint device (e.g., a desktop computer, a laptop computer, or a mobile device) and monitors for cybersecurity issues arising on the endpoint device and/or protects the endpoint device against cybersecurity issues. In some examples, the endpoint security agent may be deployed on the endpoint device as a fabric agent that delivers protection, compliance, and secure access in a single, modular, lightweight client. A fabric agent may be endpoint software that runs on an endpoint device and communicates with a telemetry connection or a cybersecurity mesh (e.g., the Fortinet Security Fabric available from Fortinet, Inc. of Sunnyvale, CA) to provide information, visibility, and control to that device. In some examples, the endpoint security agent may be in the form of a lightweight endpoint agent that utilizes less than one percent of CPU and less than 100 MB of RAM and may leverage, among other things, various security event classification sources provided within one or more associated cloud-based security services.

A non-limiting example of an endpoint security agent is the FORTICLIENT Fabric Agent available from Fortinet, Inc. of Sunnyvale, CA. In one example, to simplify the initial deployment and offload ongoing monitoring, an endpoint security agent may be managed and/or supported by one or more endpoint-focused managed services, for example, to provide setup, deployment, configuration, vulnerability monitoring, and overall endpoint security monitoring. In the context of a CSMA, the endpoint security agent may communicate with an endpoint protection platform, one or more network security appliances, and/or one or more cloud-based security services via a telemetry connection and/or via application programming interface (API) integration. In some examples, the endpoint security agent enables remote workers to connect to the network using zero-trust principles securely and may enable both Universal ZTNA and Virtual Private Network (VPN)-encrypted tunnels, as well as URL filtering and cloud access security broker (CASB). The endpoint security agent may additionally provide enhanced security capabilities through artificial intelligence (AI)-based NGAV, endpoint quarantine, and application firewall, as well as support for cloud sandbox, USB device control, and ransomware protection.

As used herein, a “network security appliance” or a “network security device” generally refers to a device or appliance in virtual or physical form that is operable to perform one or more security functions. A network security device may reside within the particular network that it is protecting, or network security may be provided as a service with the network security device residing in the cloud. Some network security devices may be implemented as general-purpose computers or servers with appropriate software to perform one or more security functions. Other network security devices may include custom hardware (e.g., one or more custom Application-Specific Integrated Circuits (ASICs)).

For example, while there are differences among network security device vendors, network security devices may be classified into three general performance categories, including entry-level, mid-range, and high-end network security devices. Each category may use different types and forms of central processing units (CPUs), network processors (NPs), and content processors (CPs). NPs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines one or more CPUs, CPs, and NPs. Mid-range network security devices may include one or more multi-core CPUs, one or more separate NP Application-Specific Integrated Circuits (ASICs), and one or more CP ASICs. At the high end, network security devices may have multiple NPs and/or multiple CPs. A network security device is typically associated with a particular network (e.g., a private enterprise network) on behalf of which it provides one or more security functions.

Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VOIP) support, Virtual Private Networking (VPN), data loss prevention (DLP), antispam, antispyware, logging, reputation-based protections, event correlation, network access control, vulnerability management, and the like. Such security functions may be deployed individually as part of a point solution or in various combinations as a unified threat management (UTM) solution.

Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDOS family of DOS attack detection and mitigation appliances).

As used herein, “Zero-Trust Network Access” or “ZTNA” generally refers to a set of technologies and functionalities that enable secure access to internal applications for local or remote users (e.g., utilizing on-net endpoint or client devices within an enterprise network or off-net endpoint or client devices outside of the enterprise network, respectively). ZTNA represents the evolution of VPN remote access, bringing the zero-trust model to application access. ZTNA may be used to authenticate and authorize access to resources based on identity, device, and/or contextual data. ZTNA solutions typically grant access on a per-session basis to individual applications only after devices and users are verified.

As used herein, a “ZTNA Access Point” or “ZTNA AP” generally refers to any hardware device, software application, or combination of hardware and software that may be used to control access to protected network devices, servers, resources, services, TCP applications, and/or databases by a requesting endpoint device. In some cases, a ZTNA AP runs one or more access proxies, including a TFAP. Depending on the particular implementation, a ZTNA may be provided in virtual or physical form. For example, a ZTNA AP may be a virtual node or container that runs one or more access proxies or a network security appliance (e.g., a UTM appliance) that runs one or more access proxies.

As used herein, a “secure connection” generally refers to a connection provided through a computer network by one or more protocols that secure communication and data transfers via the connection, for example, via end-to-end encryption. Non-limiting examples by which a secure connection may be established include HTTPS, Hypertext Transport Protocol version 1.1 (HTTP 1.1) over SSL, Hypertext Transfer Protocol version 2.0 (HTTP 2.0) over SSL, Hypertext Transfer Protocol version 3.0 (HTTP 3.0) over Quick User Datagram Protocol (UDP) Internet Connections (QUIC).

A “computer” or “computer system” may be one or more physical computers, virtual computers, or computing devices. As an example, a computer may be one or more server computers, cloud-based computers, cloud-based clusters of computers, virtual machine instances, or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers unless expressly stated otherwise.

The terms “connected” or “coupled” and related terms are used in an operational sense and are not necessarily limited to a direct connection or coupling. Thus, for example, two devices may be coupled directly or via one or more intermediary media or devices. As another example, devices may be coupled so that information can be passed between them without sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” “in an example,” “in some examples,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of an architecture that can provide endpoint client authentication and application access control in a zero-trust network access (ZTNA) environment.

FIG. 2 is a timing diagram of an example initialization phase corresponding to an architecture that can provide endpoint client authentication and application access control in a zero-trust network access (ZTNA) environment.

FIG. 3 is a timing diagram of an example operation phase corresponding to an architecture that can provide endpoint client authentication and application access control in a zero-trust network access (ZTNA) environment.

FIG. 4 is an example of a system to perform an example initialization phase corresponding to an architecture that can provide endpoint client authentication and application access control in a zero-trust network access (ZTNA) environment.

FIG. 5 is an example of a system to perform an example operational phase corresponding to an architecture that can provide endpoint client authentication and application access control in a zero-trust network access (ZTNA) environment.

FIG. 6 is a block diagram that illustrates a computer system in which or with which an embodiment of the present disclosure may be implemented.

### DETAILED DESCRIPTION

As described in greater detail below, various approaches focus on authentication of the source application of the endpoint to achieve the least privilege based on source application attributes. Additionally, the described approaches can help address challenges in application detection on network firewalls and Zero-trust network access (ZTNA) gateways.

Network firewalls are a commonly used security solution that helps organizations apply least privilege principles to network access. Network firewalls also help to gain visibility and control over transferred data by applying deep packet inspection (DPI). With DPI, network firewalls can be configured to apply least privilege principles on the network application level. This allows certain applications to access network segments while at the same time preventing unwanted applications from further communication across networks.

To implement this configuration, a network administrator would access the network firewall's user interface (UI), select one or many application signatures from a pre-defined list, and set the access permissions (e.g., allow, deny, etc.). However, this set of application signatures is usually based on detection at the network level using DPI. There are also solutions with which the server applications can be determined based on defined IP addresses, protocols, and ports. However, current solutions do not offer any possibility of configuring access control based on the client application initiating the connection. This results in a technical gap, as the accessing client application is not considered when implementing least-privilege principles. In some scenarios, however, precisely this configuration is required to configure access to particularly sensitive resources as granularly as possible. For example, NIST SP-800-162 defines the roles subject and object for attribute-based access control. Various approaches described herein address the configuration of the “application subject” role.

Another problem addressed by the approaches described herein is related to the nature of DPI. The detection of applications with DPI is done based on signature matching algorithms which usually requires network traffic to be available in plain text. Therefore, a network firewall must decrypt traffic to classify a network application correctly. With technical progress and the increasing use of public key pinning (PKP), decryption of network traffic on a network firewall and thus this type of classification is becoming increasingly difficult.

In addition, detection with DPI is limited to the actual data stream. This means that the correct network service may be recognized with DPI and application control functionality, but this method cannot determine the exact client application. This may allow users or attackers to use arbitrary client applications to transfer data over the network. For example, if an attacker uses Powershell on a Windows operating system computer to download malware from a cloud provider, network-based application detection would likely only detect HTTPS traffic or the cloud provider as the network application. The problem is that existing network firewall mechanisms do not question whether the client application is legitimate. The proposed mechanisms described below offer additional options to limit access to cloud applications and other network resources protected by a network firewall for every client application.

Example approaches herein utilize an endpoint agent to monitor the software install base of an endpoint device. To detect which client application establishes a network connection over a network firewall or a ZTNA gateway, the components, in an example, rely on encapsulation over a mTLS HTTPS tunnel (also referred to as ZTNA proxy connection). Alternative protocols can also be supported and/or utilized. When a client application tries to access a network resource, the endpoint agent detects the process from where the connection originated and enforces encapsulation over the ZTNA proxy connection. The relevant information about the client application is added in real time by the endpoint agent and evaluated by the ZTNA gateway during access. This allows access control rules based on the client application attribute. In an example, the components go through an initialization phase to synchronize information about applications in an organization's environment.

Currently, no real-time solutions address the application subject attribute for ABAC and zero-trust architectures, according to NIST SP 800-207.

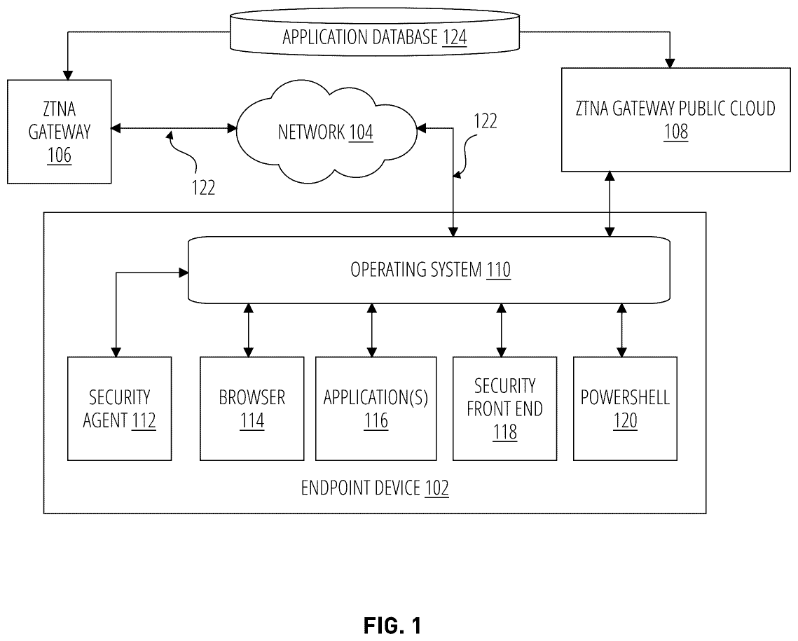

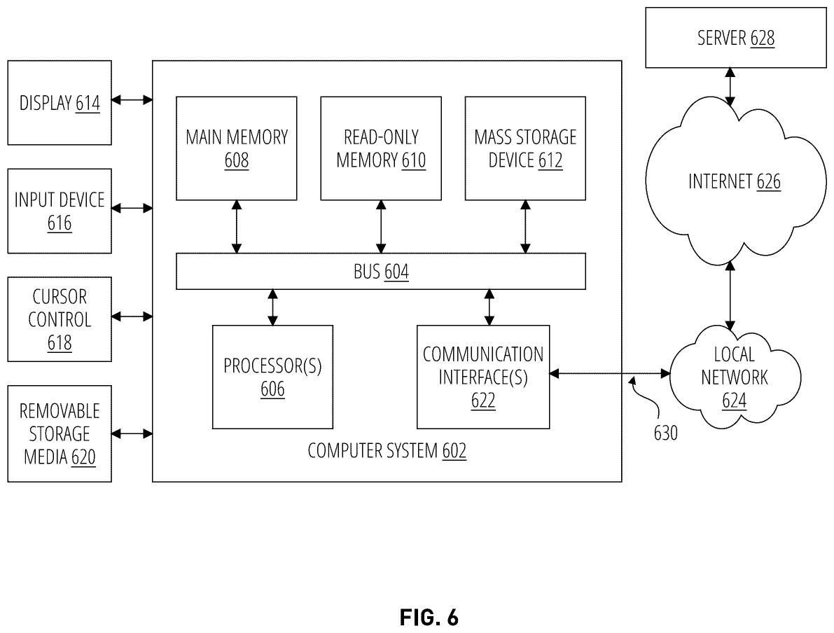

FIG. 1 is a block diagram of an architecture that can provide endpoint client authentication and access application control in a zero-trust network access (ZTNA) environment. In the example of FIG. 1, endpoint device 102 can be configured to communicate with ZTNA Gateway 106 and/or ZTNA gateway public cloud 108. In the example of FIG. 1, 102 communicates with ZTNA Gateway 106 over network 104, which can be any combination of networks (e.g., wired and/or wireless using various network protocols. In other configurations, endpoint device 102 can be configured to communicate with any number of ZTNA gateways and/or any number of ZTNA gateway public clouds. Endpoint device 102 can include additional components (for example, as illustrated in FIG. 6) to provide additional and/or different functionality.

In an example, endpoint device 102 can include operating system 110, which performs various options central to the operation of endpoint device 102. Endpoint device 102 further includes browser 114, which can allow a user of endpoint device 102 to access resources via network 104. Application(s) 116 can be any group of applications installed on endpoint device 102. Security agent 112 and security front end 118 can work together to provide ZTNA and other security functionality to endpoint device 102. Powershell 120 is a task automation and configuration management system available from Microsoft. Other automation tools can be supported similarly.

As described in greater detail below, in an example, security agent 112 tracks application inventory (e.g., application(s) 116) of endpoint device 102, maintains application integrity, enforces secure ZTNA proxy connections with ZTNA Gateway 106 (and/or ZTNA gateway public cloud 108), and maintains telemetry connections with the endpoint security manager. In an example, an endpoint management system (e.g., security agent 112, security front end 118 and ZTNA Gateway 106) aggregates application inventory of endpoints (e.g., application(s) 116 of endpoint device 102), provides central management capabilities for security agent 112, acts as a central authority to establish trust between security agent 112 and ZTNA Gateway 106. In an example, the telemetry connection is used to aggregate the application inventory, for central management and/or for central trust authority.

In an example, ZTNA Gateway 106 verifies trust of ZTNA connections, acts as Policy Enforcement Point, contains the configuration of allowed client applications (e.g., from application(s) 116). In an example, application database 124 provides pre-classification of application categories and risk levels, which helps administrators to configure allow-lists based on meta information.

In an example, when one of application(s) 116 attempts to access a resource through ZTNA Gateway 106, the connection is encapsulated into ZTNA tunnel 122 and forwarded to ZTNA Gateway 106 according to the configuration(s) of security agent 112. In this example, ZTNA tunnel 122 is authenticated with a device (e.g., endpoint device 102) certification. As another example, if an application (e.g., Microsoft Word (from application(s) 116)) attempts to access a cloud resource (part of or through ZTNA gateway public cloud 108), the connection is encapsulated into ZTNA tunnel 122 and forwarded to ZTNA gateway public cloud 108 according to the configuration(s) of security agent 112. In this example, ZTNA tunnel 122 is authenticated with a device (e.g., endpoint device 102) certification. In these two examples, the source application is not verified by default (e.g., one of application(s) 116), which could allow another application to access the requested resources via the ZTNA tunnel. This condition can become critical if an attacker is able to persist on endpoint device 102 and use, for example, powershell 120 to attack resources using ZTNA tunnel 122.

The potential vulnerabilities described in the two examples above occur because an application (e.g., from application(s) 116) can use every configured ZTNA channel (e.g., ZTNA tunnel 122) of the endpoint device (e.g., endpoint device 102) and therefore access every authorized resource as long as the logged-in user of the endpoint device is allowed by the ZTNA gateway (e.g., ZTNA Gateway 106, ZTNA gateway public cloud 108) to access the resource(s). This is because the ZTNA gateway does not know the source application. One way to detect the source application is through Deep Packet Inspection (DPI) techniques.

In the examples below, an application identifier (app ID) provides additional protection for resources accessed via ZTNA channels and/or ZTNA gateways. In an example, each application is segmented into a dedicated ZTNA tunnel, and the corresponding source application is authenticated.

As described below, authenticating the client application could lower the backend attack surface exposed to a potential attacker. Any attacker who has successfully compromised an endpoint (e.g., endpoint device 102) would then have to hijack (or otherwise compromise) a process to access the ZTNA backend of the corresponding application. A lack of application version control could potentially allow deprecated, unwanted, or vulnerable versions of client applications to access ZTNA destinations. In an example, microsegmentation and authentication of the client application together with the verification of the version of the application would allow administrators to block unwanted, unknown or unpatched applications while applications would concurrently be allowed to access ZTNA resources. The approaches described herein address application control challenges by forwarding the information that the client application is trying to access a ZTNA-protected resource to the ZTNA gateway in real time. The ZTNA gateway can use the information provided by the client device (e.g., via security agent 112) to make decisions with the application control feature(s) without the need to inspect encrypted traffic.

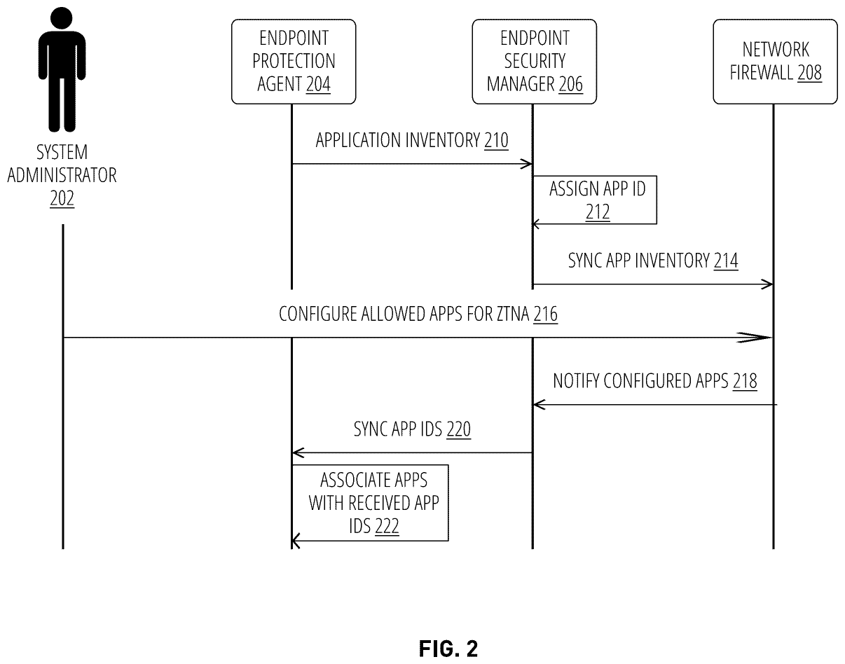

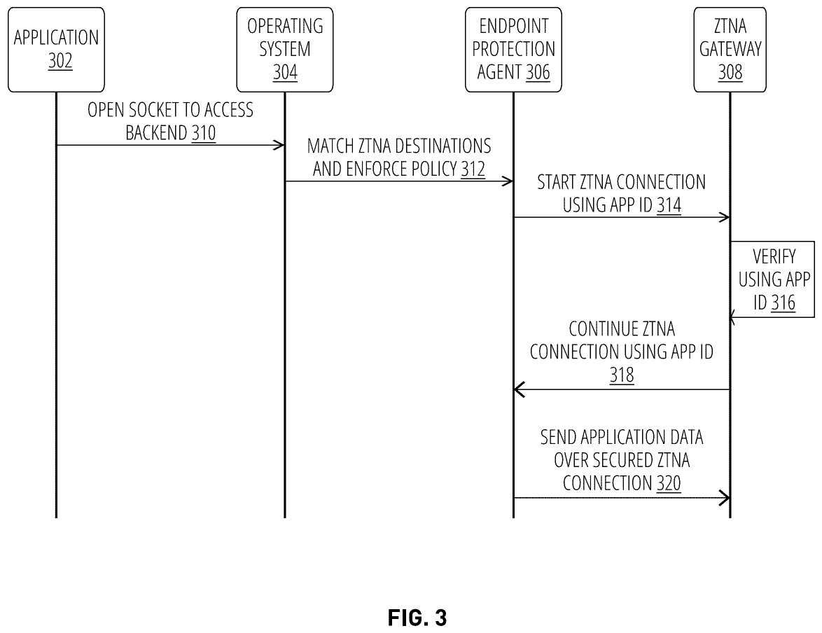

FIG. 2 is a timing diagram of an example initialization phase corresponding to an architecture that can provide endpoint client authentication and application access control in a zero-trust network access (ZTNA) environment. Conceptually, the flow for a network access can be separated into an initialization phase (FIG. 2) and an operation phase (FIG. 3). FIG. 2 illustrates an example initialization during which the systems exchange information about the endpoint application(s) in place within the computing environment.

In an example, the endpoint agent (e.g., endpoint protection agent 204) creates an inventory of all installed applications on the endpoint, 210, and sends it to endpoint security manager 206. Endpoint security manager 206 assigns an application identifier (App ID) to each application, 212. The inventory is synchronized to between endpoint protection agent 204 and endpoint security manager 206. In an example, endpoint security manager 206 accepts the software inventory and merges it with its local database where the software inventory of other agents could already be represented. In an example, the database entries are created for every software release version of the application. The EMS will also create a unique “AppID” for every application present in the organization's environment.

In an example, the software inventory together with the unique AppID is synced to the network firewall 208 to enable configuration of access control rules, 214. In addition, network firewall 208 (or a firewall) can download a feed with a pre-categorization of applications. Administrators (e.g., system administrator 202) can use this information to create access control rules based on detected and synced client applications, 216. Administrators can select the single applications from the synced software inventory with an action (e.g. allow, deny, log-only, quarantine, etc.) or whole categories of applications which match multiple applications from the inventory. Such a category, for instance, could be “General Business”, “Update Service”, “Social Media”, etc. or a risk score, e.g. “medium risk”, “high risk”.

In an example, network firewall 208 matches the selected categories with the actual AppIDs and returns a list of allowed AppIDs to endpoint security manager 206, 218. In an example, endpoint protection agent 204 takes the list of allowed AppIDs and synchronizes it with relevant information from the software inventory to the endpoint agents over a secure telemetry channel, 220. After this information is received by the endpoint agents, local rules for ZTNA access are updated, 222, so that when later allowed applications try to communicate over a ZTNA proxy tunnel, the correct AppID is added for communication.

In an example, endpoint protection agent 204 continuously monitors the software inventory of an endpoint device (e.g., endpoint device 102), changes such as new installations, updates and un-installations are noticed and communicated to endpoint security manager 206. In an example, endpoint protection agent 204 can maintain the integrity of endpoint applications (e.g., application(s) 116) by preventing unauthorized modification. Optionally, the endpoint protection agent 204 can maintain the authenticity of an application by checking if the application binary is signed by a trusted central authority, for example.

FIG. 3 is a timing diagram of an example operation phase corresponding to an architecture that can provide endpoint client authentication and application access control in a zero-trust network access (ZTNA) environment.

Once the initialization phase (FIG. 2) is completed, the systems are ready for operation. An an example, when an application tries to access a network resource by opening a socket, 310, the connection's destination is matched against a list of rules provided by the endpoint agent, 312. If a rule matches, the application's traffic is redirected to the ZTNA gateway based on the rule, 312. In an example, endpoint protection agent 306 encapsulates the application traffic in a new (e.g., HTTPS-based), secure tunnel, 314.

In an example, endpoint protection agent 306 verifies which client application initiated the connection. In an example, if the application is present in the configured list of allowed applications, endpoint protection agent 306 will add a header to the corresponding tunnel containing the AppID. In the example of an HTTPS tunnel, it can be secured by mTLS so that endpoint protection agent 306 ensures trust with ZTNA gateway 308 and vice versa. This approach can prevent third parties from modifying the headers of the tunnel and ensure that data received by ZTNA gateway 308 is confidential and integer. In an example, ZTNA gateway 308 checks if an AppID is present in the tunnel header, 316. If yes, the AppID is matched with the access control rules defined by the administrator (e.g., configure allowed apps for ZTNA 216 in FIG. 2). In an example, the network firewall (e.g., network firewall 208) will handle the connection according to the access control rules defined and continue the connection establishment (e.g., continue ZTNA connection using app ID 318, send application data over secured ZTNA connection 320) if the app (and other access control criteria) matches an “allow” rule.

Knowing which client application initiated a connection to a network resource is more than useful from a network firewall perspective. It not only allows additional visibility and control at the network firewall level, but it also enables micro-segmentation by offering the possibility to create granular rules. The endpoint agent could be configured to forward all network traffic to the ZTNA gateway. This allows network administrators to have full control over the network communication of an endpoint device from the network firewall level.

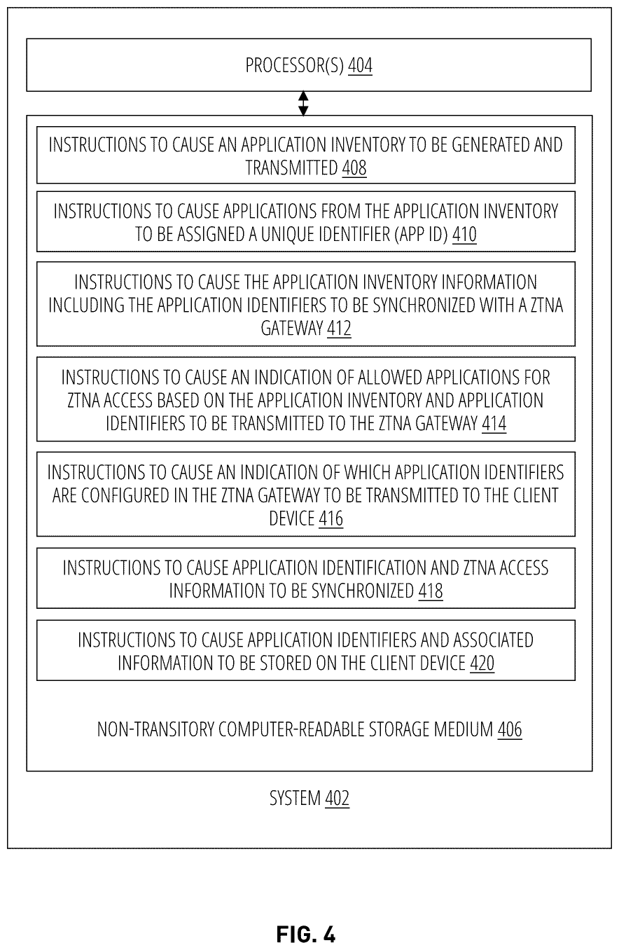

FIG. 4 is an example of a system to perform an example initialization phase corresponding to an architecture that can provide endpoint client authentication and application access control in a zero-trust network access (ZTNA) environment. In an example, system 402 can include processor(s) 404 and non-transitory computer-readable storage medium 406. Non-transitory computer-readable storage medium 406 may store instructions 408, 410, 412, 414, 416, 418 and 420 that, when executed by processor(s) 404, cause processor(s) 404 to perform various functions. Examples of processor(s) 404 may include a microcontroller, a microcontroller, a microprocessor, a central processing unit (CPU), a graphics processing unit (GPU), a data processing unit (DPU), an application-specific integrated circuit (ASIC), a field programmable gate array (FPGA), a system on a chip (SoC), etc. Examples of non-transitory computer-readable storage medium 406 include tangible media such as random-access memory (RAM), read-only memory (ROM), electrically erasable programmable read-only memory (EEPROM), flash memory, a hard disk drive, etc.

Instructions 408 cause processor(s) 404 to cause an application inventory to be generated and transmitted. In an example, the application inventory includes all of the applications (e.g., application(s) 116) installed on a corresponding client system. However, in other configurations, a subset of applications (e.g., applications that are eligible for ZTNA resource access, applications that have network access permissions) are included in the inventory. The application inventory can be transmitted between components of the client system and/or to external components (e.g., a security management service).

Instructions 410 cause processor(s) 404 to cause application identifiers (app IDs) to be assigned to applications in the application inventory. In an example, the application identifier is a number or other type of identifier that is associated with an application. The mapping of application identifiers to applications can be stored in a database or other type of table, for example. In an example, the application identifiers are used to identify applications utilizing ZTNA (or other) tunnels to provide additional security/authentication. In an example, the application identifier is included in an HTTPS header. Other configurations can also be supported.

Instructions 412 cause processor(s) 404 to cause the application inventory information (including the application identifiers) to be synchronized with at least one ZTNA gateway (e.g., ZTNA gateway 308).

Instructions 414 cause processor(s) 404 to cause an indication of allowed applications for ZTNA access (based on application inventory and/or application identifier) to be transmitted to the ZTNA gateway. In an example, the indication of allowed applications for ZTNA access can be received from a system administrator or other similar entity. Preconfigured lists can also be utilized.

Instructions 416 cause processor(s) 404 to cause an indication of which application identifiers are configured in the ZTNA gateway to be transmitted to the client device. Instructions 418 cause processor(s) 404 to cause application identification and ZTNA access information to be synchronized as necessary. Instructions 418 cause processor(s) 404 to cause application identifiers and associated information to be stored on the client device.

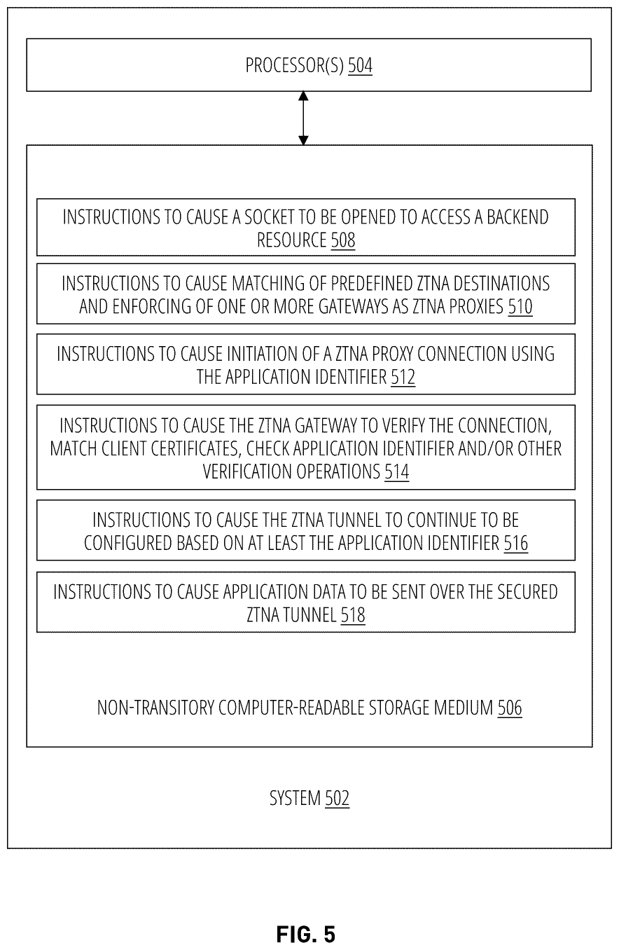

FIG. 5 is an example of a system to perform an example operational phase corresponding to an architecture that can provide endpoint client authentication and application access control in a zero-trust network access (ZTNA) environment. In an example, system 502 can include processor(s) 504 and non-transitory computer-readable storage medium 506. Non-transitory computer-readable storage medium 506 may store instructions 508, 510, 512, 514, 516 and 518 that, when executed by processor(s) 504, cause processor(s) 504 to perform various functions. Examples of processor(s) 504 may include a microcontroller, a microcontroller, a microprocessor, a central processing unit (CPU), a graphics processing unit (GPU), a data processing unit (DPU), an application-specific integrated circuit (ASIC), a field programmable gate array (FPGA), a system on a chip (SoC), etc. Examples of non-transitory computer-readable storage medium 506 include tangible media such as random-access memory (RAM), read-only memory (ROM), electrically erasable programmable read-only memory (EEPROM), flash memory, a hard disk drive, etc.

Instructions 508 cause processor(s) 504 to cause a socket to be opened to access a backend resource. The socket is to connect a requesting application with an appropriate backend resource over a network connection. In an example, the request comes from the requesting application and is transmitted to the operating system of the host platform on which the application resides.

Instructions 510 cause processor(s) 504 to cause matching of predefined ZTNA destinations and enforcement of one or more ZTNA gateways as ZTNA proxies.

Instructions 512 cause processor(s) 504 to cause the initiation of a ZTNA proxy connection using at least the application identifier. In an example, the application identifiers are used to identify applications utilizing ZTNA (or other) tunnels to provide additional security/authentication. In an example, the application identifier is included in an HTTPS header. Other configurations can also be supported.

Instructions 514 cause processor(s) 504 to cause the ZTNA gateway to verify the connection with the application, match client certificates and/or use the application identifier to verify the connection with the requesting application. Additional and/or different authentication/verification techniques can also be utilized.

Instructions 516 cause processor(s) 504 to cause an indication of which application identifiers are configured in the ZTNA gateway to be transmitted to the client device. Instructions 518 cause processor(s) 504 to cause application data to be sent over the secured ZTNA tunnel.

FIG. 6 is a block diagram that illustrates a computer system in which or with which an embodiment of the present disclosure may be implemented (e.g., endpoint device 102). Computer system 602 may be representative of an endpoint or client device (e.g., one of the off-net clients or on-net clients) on which an endpoint security agent is running and acting as a proxy on behalf of a client application (e.g., a browser). Notably, components of computer system 602 described herein are meant only to exemplify various possibilities. In no way should example computer system 602 limit the scope of the present disclosure. In the context of the present example, computer system 602 includes bus 604 or other communication mechanism for communicating information and one or more processing resources (e.g., one or more hardware processor(s) 606) coupled with bus 604 for processing information. Hardware processor(s) 606 may include, for example, one or more general-purpose microprocessors available from one or more current or future microprocessor manufacturers (e.g., Intel Corporation, Advanced Micro Devices, Inc., and/or the like) and/or one or more special-purpose processors (e.g., CPs, NPs, and/or accelerators or co-processors). In some examples, one or more processing resources may be part of an ASIC-based security processing unit (e.g., the FORTISP family of security processing units available from Fortinet, Inc. of Sunnyvale, CA).

Computer system 602 also includes main memory 608, such as a random-access memory (RAM) or other dynamic storage device, coupled to bus 604 for storing information and instructions to be executed by processor(s) 606. Main memory 608 also may be used for storing temporary variables or other intermediate information during execution of instructions to be executed by processor(s) 606. Such instructions, when stored in non-transitory storage media accessible to processor(s) 606, render computer system 602 into a special-purpose machine customized to perform the operations specified in the instructions.

Computer system 602 includes a read-only memory 610 or other static storage device coupled to bus 604 for storing static information and instructions for processor(s) 606. Mass storage device 612 (e.g., a magnetic disk, optical disk or flash disk (made of flash memory chips), is provided and coupled to bus 604 for storing information and instructions.

Computer system 602 may be coupled via bus 604 to display 614 (e.g., a cathode ray tube (CRT), Liquid Crystal Display (LCD), Organic Light-Emitting Diode Display (OLED), Digital Light Processing Display (DLP) or the like, for displaying information to a computer user. Input device 616, including alphanumeric and other keys, is coupled to bus 604 for communicating information and command selections to processor(s) 606. Another type of user input device is cursor control 618, such as a mouse, a trackball, a trackpad, or cursor direction keys for communicating direction information and command selections to processor(s) 606 and for controlling cursor movement on display 614. This input device typically has two degrees of freedom in two axes, a first axis (e.g., x) and a second axis (e.g., y), that allows the device to specify positions in a plane.

Removable storage media 620 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 602 may implement the techniques described herein using customized hard-wired logic, one or more ASICs or FPGAs, firmware or program logic which in combination with the computer system causes or programs computer system 602 to be a special-purpose machine. According to one embodiment, the techniques herein are performed by computer system 602 in response to processor(s) 606 executing one or more sequences of one or more instructions contained in main memory 608. Such instructions may be read into main memory 608 from another storage medium, such as mass storage device 612. Execution of the sequences of instructions contained in main memory 608 causes processor(s) 606 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic, or flash disks, such as mass storage device 612. Volatile media includes dynamic memory, such as main memory 608. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wires, and fiber optics, including the wires that comprise bus 604. Transmission media can also be acoustic or light waves, such as those generated during radio-wave and infrared data communications.

Various forms of media may be involved in carrying one or more sequences of one or more instructions to processor(s) 606 for execution. For example, the instructions may initially be carried on a magnetic disk or solid-state drive of a remote computer. The remote computer can load the instructions into its dynamic memory and send the instructions over a telephone line using a modem. A modem local to computer system 602 can receive the data on the telephone line and use an infra-red transmitter to convert the data to an infra-red signal. An infra-red detector can receive the data from the infra-red signal, and appropriate circuitry can place the data on bus 604. Bus 604 carries the data to main memory 608, from which processor(s) 606 retrieve and execute the instructions. The instructions received by main memory 608 may optionally be stored on mass storage device 612 either before or after execution by processor(s) 606.

Computer system 602 also includes communication interface(s) 622 coupled to bus 604. Communication interface(s) 622 provides a two-way data communication coupling to network link 630 that is connected to local network 624. For example, communication interface(s) 622 may be an integrated services digital network (ISDN) card, cable modem, satellite modem, or a modem to provide a data communication connection to a corresponding type of telephone line. Another example is communication interface(s) 622, which may be a local area network (LAN) card that provides a data communication connection to a compatible LAN. Wireless links may also be implemented. In any such implementation, communication interface(s) 622 sends and receives electrical, electromagnetic or optical signals that carry digital data streams representing various types of information.

Network link 630 typically provides data communication through one or more networks to other data devices. Local network 624 and internet 626 both use electrical, electromagnetic or optical signals that carry digital data streams. The signals through the various networks and network link 630 and through communication interface(s) 622, which carry the digital data to and from computer system 602, are example forms of transmission media.

Computer system 602 can send messages and receive data, including program code, through the network(s), network link 630 and communication interface(s) 622. In the Internet example, server 628 might transmit a requested code for an application program through internet 626, local network 624 and communication interface(s) 622. The received code may be executed by processor(s) 606 as it is received or stored in mass storage device 212 or other non-volatile storage for later execution.

Embodiments may be implemented as any or a combination of one or more microchips or integrated circuits interconnected using a parent board, hardwired logic, software stored by a memory device and executed by a microprocessor, firmware, an application-specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include but is not limited to, floppy diskettes, optical disks, CD-ROMs (Compact Disc-Read Only Memories), magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

The drawings and the forgoing description give examples of embodiments. Those skilled in the art will appreciate that one or more of the described elements may be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown, nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as the following claims.

Reference in the specification to “one example” or “an example” means that a particular feature, structure, or characteristic described in connection with the example is included in at least one embodiment of the disclosure. The appearances of the phrase “in one example” in various places in the specification do not necessarily refer to the same embodiment.

It is contemplated that any number and type of components may be added to and/or removed to facilitate various embodiments, including adding, removing, and/or enhancing certain features. For brevity, clarity, and case of understanding, many standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

The terms “component,” “module,” “system,” and the like as used herein are intended to refer to a computer-related entity, either software-executing general-purpose processor, hardware, firmware, or a combination thereof. For example, a component may be, but is not limited to, a process running on a processor, a processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various non-transitory, computer-readable media with various data structures stored thereon. The components may communicate via local and/or remote processes, such as in accordance with a signal having one or more data packets (e.g., data from one component interacting with another component in a local system, distributed system, and/or across a network such as the Internet with other systems via the signal).

Computer-executable components can be stored, for example, on non-transitory, computer-readable media including, but not limited to, an ASIC, CD, DVD, ROM, floppy disk, hard disk, EEPROM, memory stick or any other storage device type, in accordance with the claimed subject matter.

What is claimed is:

1. A method comprising:
processing a request for an application to access a remote secure resource via a secure network connection, wherein the request comprises at least an application identifier assigned by a security device;
maintaining an application inventory for an endpoint device, the application inventory having a list of applications installed on the endpoint device with corresponding application identifiers;
synchronizing the application inventory with at least one remote device;
opening a network connection to allow the application to access the remote secure resource, wherein the network connection is limited to use by the application as determined at least by the application identifier corresponding to the application and other applications with different corresponding application identifiers are excluded from the network connection;
receiving a verification of establishment of the network connection to allow access to the remote secure resource; and
transmitting application data from the application over the network connection to access the remote secure resource.

2. The method of claim 1 wherein the secure network connection comprises a zero-trust network access (ZTNA) connection.

3. The method of claim 2, wherein separate ZTNA tunnels are opened for applications in the application inventory.

4. The method of claim 1 further comprising synchronizing verification information including an application identifier between a group of security components coupled with the network.

5. The method of claim 4, wherein the security components comprise at least a client device having a security agent and a gateway device coupled via the network.

6. The method of claim 1, wherein the network connection comprises a zero-trust network access (ZTNA) network connection.

7. The method of claim 6, wherein the application identifier is included in at least one packet header of traffic over the ZTNA network connection.

8. A non-transitory computer readable medium having stored thereon instructions that, when executed by one or more processors, cause the one or more processors to:
process a request for an application to access a remote secure resource via a secure network connection, wherein the request comprises at least an application identifier assigned by a security device;
maintain an application inventory for an endpoint device, the application inventory having a list of applications installed on the endpoint device with corresponding application identifiers;
synchronize the application inventory with at least one remote device;
open a network connection to allow the application to access the remote secure resource, wherein the network connection is limited to use by the application as determined at least by the application identifier corresponding to the application and other applications with different corresponding application identifiers are excluded from the network connection;
receive a verification of establishment of the network connection to allow access to the remote secure resource; and
transmit application data from the application over the network connection to access the remote secure resource.

9. The non-transitory computer readable medium of claim 8 wherein the secure network connection comprises a zero-trust network access (ZTNA) connection.

10. The non-transitory computer readable medium of claim 9, wherein separate ZTNA tunnels are opened for applications in the application inventory.

11. The non-transitory computer readable medium of claim 8 further comprising instructions that, when executed, cause the one or more processors to synchronize verification information including an application identifier between a group of security components coupled with the network.

12. The non-transitory computer readable medium of claim 11, wherein the security components comprise at least a client device having a security agent and a gateway device coupled via the network.

13. The non-transitory computer readable medium of claim 8, wherein the network connection comprises a zero-trust network access (ZTNA) network connection.

14. The non-transitory computer readable medium of claim 13, wherein the application identifier is included in at least one packet header of traffic over the ZTNA network connection.

15. A system comprising:
a memory subsystem having at least one memory device;
one or more hardware processors coupled with the memory subsystem, the one or more processors configured to:
process a request for an application to access a remote secure resource via a secure network connection, wherein the request comprises at least an application identifier assigned by a security device;
maintain an application inventory for an endpoint device, the application inventory having a list of applications installed on the endpoint device with corresponding application identifiers;
synchronize the application inventory with at least one remote device;
open a network connection to allow the application to access the remote secure resource, wherein the network connection is limited to use by the application as determined at least by the application identifier corresponding to the application and other applications with different corresponding application identifiers are excluded from the network connection;
receive a verification of establishment of the network connection to allow access to the remote secure resource; and
transmit application data from the application over the network connection to access the remote secure resource.

16. The system of claim 15, wherein the secure network connection comprises a zero-trust network access (ZTNA) connection.

17. The system of claim 15, wherein the network connection comprises a zero-trust network access (ZTNA) network connection.

18. The system of claim 17, wherein the application identifier is included in at least one packet header of traffic over the ZTNA network connection.

19. The system of claim 15 wherein the one or more hardware processors are further configured to further comprising instructions that, when executed, cause the one or more processors to synchronize verification information including an application identifier between a group of security components coupled with the network.

20. The system of claim 19, wherein the security components comprise at least a client device having a security agent and a gateway device coupled via the network.
